(19) United States
(12) Patent Application Publication
(10) Pub. No.: US 2016/0132859 A1
(43) Pub. Date: May 12, 2016

(54) INITIATING PEER-TO-PEER TRANSACTIONS WITH A MAGNETIC STRIP CARD

(71) Applicants: Travis Harrison Kroll Green, New York, NY (US); Avery Pennarun, New York, NY (US)

(72) Inventors: Travis Harrison Kroll Green, New York, NY (US); Avery Pennarun, New York, NY (US)

(73) Assignee: GOOGLE Inc., Mountain View, CA (US)

(21) Appl. No.: 13/436,819

(22) Filed: Mar. 30, 2012

(51) Int. Cl. G06Q 20/40; G06Q 20/42; G06Q 20/32; G06Q 20/20; G06Q 20/34

(52) U.S. Cl. CPC G06Q 20/223; G06Q 20/204; G06Q 20/327; G06Q 20/42

(57) ABSTRACT

The present invention provides a computer-implemented method to conduct a peer-to-peer transaction. A peer-to-peer transaction system receives a request for transaction approval from a merchant network device. The request includes user account information captured from a magnetic strip card encoded with the user account information and transaction information. The peer-to-peer transaction system determines that the transaction information is valid; transmits a request for authorization of the transaction to a user network device; receives an indication that the user authorized the transaction; transmits an approval of the transaction to a merchant network device; and conducts the transaction.

### TECHNICAL FIELD

The present disclosure relates generally to peer-to-peer transactions, and more particularly to initiating peer-to-peer transactions with a magnetic strip card at a merchant location.

### BACKGROUND

Peer-to-peer (“P2P”) transactions allow a party to transfer money with other parties quickly, securely, and inexpensively. Users often conduct P2P transactions with mobile devices, via email, online, and in other convenient manners. When conducting a transaction with another user, P2P transactions are more traceable than cash, faster than a check, and don't require one party to be capable of accepting a credit card payment.

Many modern merchants accept P2P payments for online transactions, but physical merchants do not. A physical merchant will typically accept credit or debit cards, cash, and checks. Credit card purchases are costly to merchants. Some merchants accept P2P payments conducted between a mobile device and a point of sale terminal. However, many current mobile devices are not capable establishing a connection with a point of sale terminal. Also, many customers are not comfortable with the security of a mobile transaction with a merchant.

The transition for physical merchants to accept more P2P transactions is slow because users are accustomed to making transactions with credit cards and debit cards for purchases at physical locations. It would be desirable for merchants to be able to encourage P2P purchases from users at physical locations.

### SUMMARY

An aspect of the present invention provides a computer-implemented method to conduct a peer-to-peer transaction. A peer-to-peer (“P2P”) transaction system receives a request for transaction approval from a merchant network device. The request includes transaction information and user account information captured from a magnetic strip card encoded with the user account information. The P2P transaction system determines that the transaction information is valid; transmits a request for authorization of the transaction to a user network device; receives an indication that the user authorized the transaction; transmits an approval of the transaction to a merchant network device; and conducts the transaction.

Another aspect of the present invention provides a computer program product that is installed on a server located in a P2P system to conduct a P2P transaction. The computer program product includes a non-transitory computer-readable storage device having computer-readable program instructions embodied thereon. The computer-readable program instructions include computer program instructions to receive a request for transaction approval from a merchant network device. The request includes user account information captured by a point of sale terminal at the merchant location. The computer-readable program instructions include computer program instructions to determine that the transaction information is valid; transmit a request for authorization of the transaction to a user network device; receive an indication that the user authorized the transaction; transmit an approval of the transaction to a merchant network device; and conduct the transaction.

Another aspect of the present invention provides a system to optimize a content preview. A P2P transaction system contains a P2P system server. The server is configured to receive a request for transaction approval from a merchant network device including user account information captured from a magnetic strip card; determine that the transaction information is valid; transmit a request for authorization of the transaction to a user network device; receive an indication that the user authorized the transaction; transmit an approval of the transaction to a merchant network device; and conduct the transaction. The system provides a magnetic strip card encoded with the user account information. The system provides a user network device configured to receive a request for authorization of the transaction from the processor; receive an indication from the user of the authorization of the transaction; and transmit the authorization of the transaction.

### BRIEF DESCRIPTION OF THE DRAWINGS

FIG. 1 is a block diagram depicting an operating environment of a peer-to-peer transaction system that is configured to conduct a peer-to-peer transaction with user account information captured from a magnetic strip card, in accordance with certain exemplary embodiments.

FIG. 2 is a block flow diagram depicting a method to use a magnetic strip card to initiate a peer-to-peer transaction, in accordance with certain exemplary embodiments.

### DETAILED DESCRIPTION OF THE EXEMPLARY EMBODIMENTS

### Overview

The exemplary embodiments provide a peer-to-peer (“P2P”) transaction system that can support user financial accounts and facilitate P2P financial transactions. A user can establish a P2P account on the P2P system and transfer and receive money from other accounts on the P2P system. The financial transactions can be initiated in any manner supported by the P2P system. For example, users may transfer funds to another user via an online request, via mobile-to-mobile communications, via near field communication, or in other manners.

In the exemplary embodiment of the invention, the user associates a magnetic strip card with the P2P account. The exemplary card has a magnetic strip, such as the strip on a credit card, which can be read by a card reader such as the card reader at a merchant location. The card can be issued by the P2P system or can be any other card that the user associates with the account. For example, the user can associate a card issued by a third party or a card originally intended for another purpose such as a driver's license or a library card. Any card that can provide an account number to a card reader can be associated with the user account. In certain embodiments, the card may not provide a single, usable card identification number. The system may use any or all of the information on the card as an identifier.

A user can use the P2P account to purchase products at a physical merchant location or an online merchant. At a physical merchant, the user can select a product and approach a POS device and a card reader of the merchant.

The merchant can swipe the card through the card reader associated with a point of sale (“POS”) terminal to capture the card number and conduct the purchase transaction. In an exemplary embodiment, the merchant employs a card reader that is specifically for the P2P system that the user and the merchant are using for the transaction. In an alternate embodiment, the merchant may use a card reader that is employed for traditional cards such as credit cards and debit cards. The merchant may use the traditional card reader and extract the account number for a P2P account and conduct the transaction using the P2P system. If the merchant uses a traditional card reader, the merchant can select between a traditional credit card transaction and a P2P transaction. In one embodiment, wherein the user associates the P2P account with a traditional credit or debit card, the merchant can configure the system to attempt a P2P transaction and default to a traditional transaction if the P2P transaction is not supported or is declined. In an alternate embodiment, the merchant can select the transaction type at the time of the purchase and direct the POS terminal to the proper transaction account. If the merchant has not configured the POS terminal and the merchant system to accept P2P transactions, the merchant can process all credit or debit cards in the traditional manner. At a merchant POS terminal that does not accept P2P transactions, the user credit or debit card can default to the credit or debit account of the user.

The P2P system receives the transaction information and the account information of the user and the merchant. The transaction information may contain the account numbers, the purchase price of the product, merchant location, taxes, product identification, and other relevant data characterizing the transaction.

The P2P system transmits a request for approval of the transaction to a user network device. In an exemplary embodiment, the request is transmitted to a mobile device that the user would expect to have at the merchant location. For example, the request can be sent to a P2P transaction application operating on a smartphone of the user via an Internet connection on the network. Other manners of transmitting the message to a user network device can be employed such as email, instant message, text, a message via a proximity connection with the POS terminal, or any other technology.

The user can authorize or refuse to authorize the transaction. If the user transaction information provided to the user by the P2P system are acceptable and the user agrees to all of the terms, the user can authorize the transaction. For example, if the authorization request was presented on the P2P application on the user device, the user may click an approve button and the authorization is transmitted to the P2P system via an Internet connection over the network or by any other communication technology. Alternatively, the user may transmit an authorization to the P2P system via a text, email, instant message, or any other suitable communication method. In an alternate embodiment, the user may configure the user account to automatically accept all authorization requests from a certain merchant. That is, any P2P transaction between the user and the specified merchant will be processed without an authorization being received from the user device at the time of purchase.

The user can authorize the transaction by actuating a button or other authorization module in the communication. If the user does not authorize the transaction, the user may actuate a button or other module that refuses the transaction.

If the user refuses the transaction, the merchant is notified that the transaction is refused. Alternatively, if the user does not authorize the transaction within a configured amount of time, the transaction is refused. The deadline may elapse without an acceptance or refusal by the user because the user does not have the user device available for accepting the transaction, the user device can not communicate with the P2P system, the user chooses to ignore the request, or for any other reason.

Upon being notified that the user has not accepted the transaction, the merchant can request an alternate form of payment from the user, attempt the P2P transaction again, or end the purchase transaction completely.

The inventive functionality of the invention will be explained in more detail in the following description, read in conjunction with the figures illustrating the program flow.

### System Architecture

Turning now to the drawings, in which like numerals represent like (but not necessarily identical) elements throughout the figures, exemplary embodiments of the present invention are described in detail.

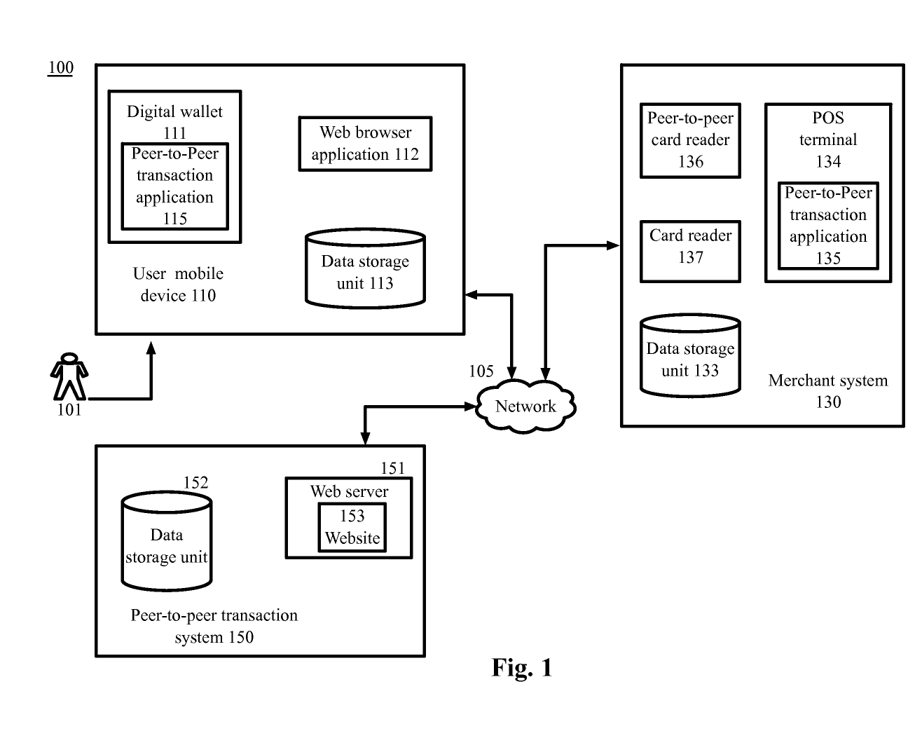

FIG. 1 is a block diagram depicting an operating environment of a peer-to-peer (“P2P”) transaction system that is configured to conduct a peer-to-peer transaction with user account information captured from a magnetic strip card, in accordance with certain exemplary embodiments. As depicted in FIG. 1, the system 100 includes network devices 110, 130 and 150 that are configured to communicate with one another via one or more networks 105.

Each network 105 includes a wired or wireless telecommunication means by which network devices (including devices 110, 130, 150) can exchange data. For example, each network 105 can include a local area network (“LAN”), a wide area network (“WAN”), an intranet, an Internet, a mobile telephone network, or any combination thereof. Throughout the discussion of exemplary embodiments, it should be understood that the terms “data” and “information” are used interchangeably herein to refer to text, images, audio, video, or any other form of information that can exist in a computer-based environment.

Each network device 110, 130 and 150 includes a device having a communication module capable of transmitting and receiving data over the network 105. For example, each network device 110, 130 and 150 can include a server, desktop computer, laptop computer, tablet computer, smart phone, handheld computer, personal digital assistant (“PDA”), or any other wired or wireless, processor-driven device. In the exemplary embodiment depicted in FIG. 1, the network devices 110, 130 and 150 are operated by end-users or consumers, merchants, and P2P transaction systems, respectively.

The user 101 can use the application 112, such as a web browser application or a stand-alone application, to view, download, upload, or otherwise access documents or web pages via a distributed network 105. The network 105 includes a wired or wireless telecommunication system or device by which network devices (including devices 110, 130, and 150) can exchange data. For example, the network 105 can include a local area network (“LAN”), a wide area network (“WAN”), an intranet, an Internet, storage area network (SAN), personal area network (PAN), a metropolitan area network (MAN), a wireless local area network (WLAN), a virtual private network (VPN), a cellular or other mobile communication network, BLUETOOTH, NFC, or any combination thereof or any other appropriate architecture or system that facilitates the communication of signals, data, and/or messages. Throughout the discussion of exemplary embodiments, it should be understood that the terms “data” and “information” are used interchangeably herein to refer to text, images, audio, video, or any other form of information that can exist in a computer based environment.

The web browser application 112 can interact with web servers or other computing devices connected to the network 105, including web server 151 of the P2P system 150, and the point of sale (“POS”) terminal 134 of the merchant system 130.

The user device 110 may include a digital wallet application module 111. The digital wallet 111 may encompass any application, hardware, software, or process the user device 110 may employ to assist the device to complete a purchase transaction. The digital wallet 111 can interact with the web browser application 112 or can be embodied as a companion application of the web browser application 112. As a companion application, the digital wallet 111 executes within the web browser application 112. That is, the digital wallet 111 may be an application program embedded in the web browser application 112.

The user device 110 includes a P2P transaction application 115. The P2P application 115 can interact with the web browser application 112 or can be embodied as companion applications of the web browser application 112. As a companion application, the P2P application 115 executes within the web browser application 112. That is, the P2P application 115 may be an application program embedded in the web browser application 112.

The P2P application 115 may further be embodied as a companion application of the digital wallet 111 and execute within the digital wallet 111. The P2P application 115 may employ a user interface that may open in the digital wallet application 111 or may open in the web browser application 112. The P2P application 115 may alternatively employ the user interface of the digital wallet 111 for operation and configuration.

The P2P application 115 may encompass any application, hardware, software, or process the user device 110 may employ to conduct P2P financial or other transactions with another network device or account.

The P2P application 115 can include a set of computer-readable program instructions, for example, using JavaScript, that enable the merchant system 130 and the P2P system 150 to interact with the P2P application 115.

The user device 110 includes a data storage unit 113 accessible by the digital wallet 111, the P2P application 115 and the web browser application 112. The exemplary data storage unit 113 can include one or more tangible computer-readable media. The data storage unit 113 can be stored on the user device 110 or can be logically coupled to the user device 110. For example, the data storage unit 113 can include on-board flash memory and/or one or more removable memory cards or removable flash memory.

The P2P system 150 utilizes a P2P server 151. The P2P server 151 may represent the computer-implemented system that the P2P system 150 employs to host user accounts, receive transaction requests, conduct transactions, and other functions necessary to host P2P transactions. The P2P server 151 operates a P2P website 153. The website 153 may be operable to communicate with a user 101 and a merchant system 130 and others to allow configuration of accounts, transaction requests, or any other purpose to manage the P2P transaction process.

The P2P system 150 can communicate with merchant systems 130 and user devices 110 via any available technologies. The technologies may include, but would not be limited to, an Internet connection via the network 105, email, text, instant messaging, or other suitable communication technologies. The P2P system 150 may include a data storage unit 152 accessible by the server 151 of the P2P system 150. The data storage unit 152 can include one or more tangible computer-readable storage devices.

The merchant system 130 may include a point of sale (“POS”) terminal 134. The merchant system 130 includes a P2P card reader 136 that is capable of reading an account number from a magnetic strip card. The merchant system 130 includes a card reader 137 for reading an account number from traditional magnetic strip cards such as credit cards and debit cards. In certain embodiments, the functions of the card reader 137 and the P2P card reader 136 are performed on the same card reader device. The card readers 136, 137 can communicate the account number information to the POS terminal 134. While the card readers 136, 137 are depicted as standalone hardware devices, the card readers 136, 137 may also be an integrated part of the POS terminal 134, in accordance with alternative exemplary embodiments.

In an alternate embodiments, the POS terminal 134 communicates with the mobile device 110 using a BLUETOOTH communication method, a Wi-Fi communication method, an NFC communication method, or other suitable method. The accepted manner of initiating a transaction between a user device 110 and a POS terminal 134 may include actuating a physical or virtual button on the user device 110, a swipe or “tap” of the user device 110, a voice command, or other suitable input.

The merchant system employs a P2P transaction application 135. The P2P application 135 may encompass any application, hardware, software, or process the merchant system 130 may employ to conduct financial or other transactions with another network device or account. The P2P application 135 may operate on the POS terminal 134 or other computing device of the merchant system 130.

The merchant system 130 may include a data storage unit 133 accessible by the POS terminal 134 and the card readers 136, 137. The data storage unit 133 can include one or more tangible computer-readable storage devices.

It will be appreciated that the network connections shown are exemplary and other means of establishing a communications link between the computers and devices can be used. Moreover, those having ordinary skill in the art having the benefit of the present disclosure will appreciate that the user device 110, merchant system 130, and P2P transaction system 150 illustrated in FIG. 1 can have any of several other suitable computer system configurations. For example, a user device 110 embodied as a mobile phone or handheld computer may not include all the components described above.

### System Process

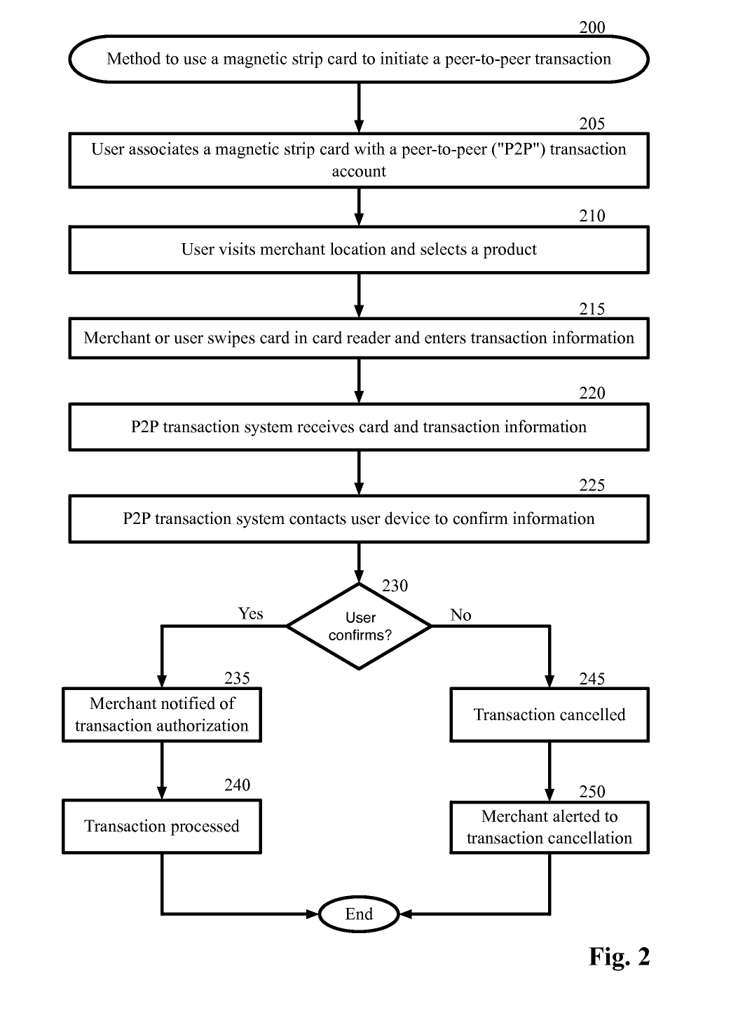

The components of the exemplary operating environment 100 are described hereinafter with reference to the exemplary methods illustrated in FIG. 2. The exemplary embodiments can include one or more computer programs that embody the functions described herein and illustrated in the appended flow charts. However, it should be apparent that there could be many different ways of implementing aspects of the exemplary embodiments in computer programming, and these aspects should not be construed as limited to one set of computer instructions. Further, a skilled programmer would be able to write such computer programs to implement exemplary embodiments based on the flow charts and associated description in the application text. Therefore, disclosure of a particular set of program code instructions is not considered necessary for an adequate understanding of how to make and use the exemplary embodiments. Further, those skilled in the art will appreciate that one or more acts described may be performed by hardware, software, or a combination thereof, as may be embodied in one or more computing systems.

FIG. 2 is a flow chart depicting a method 200 to use a magnetic strip card to initiate a peer-to-peer (“P2P”) transaction, in accordance with certain exemplary embodiments.

With reference to FIGS. 1 and 2, in block 205, a user 101 can establish a P2P account on the P2P system 150 and transfer and receive money from other accounts on the P2P system 150. A financial transaction can be initiated in any manner supported by the P2P system 150. For example, users 101 may transfer funds to a second user via an online request, via mobile communications, or in other manners.

The user 101 associates one or more magnetic strip cards with the P2P account. The exemplary card has a magnetic strip such as the strip on a credit card that can be read by a card reader such as a card reader 136 at a location of a merchant system 130. The card can be issued by the P2P system 150 or can be any other card that the user 101 associates with the account. For example, the user 101 can associate a card issued by a third party or a card originally intended for another purpose such as a driver's license or a library card. Any card that can provide an account number to a card reader 136 can be used. In certain embodiments, more than one card can be associated with the P2P account. The different cards may contain different card numbers or identification information. The P2P account is configured to accept each of the cards in a transaction.

In block 210, a user 101 can use the P2P account to purchase products at a location of a physical merchant system 130. The user 101 can select a product and approach a POS terminal 134 and a card reader 136 of the merchant 130. Throughout the specification, the term “product(s)” refers to tangible and intangible products, as well as services.

In an alternate embodiment, the user may conduct the transaction with any entity other than a merchant 130. The transaction counter-party may be any entity that possesses a card reader 136 or can otherwise conduct a P2P transaction with the user 101. In certain alternate embodiments, the transaction may be conducted with an identifier such as a phone number or other account number transfer system.

In block 215, the merchant 130 or the user 101 can swipe the card through the card reader 136 associated with a POS terminal 134 to capture the card number and conduct the purchase transaction. In an exemplary embodiment, the merchant 130 employs a card reader 136 that is specifically for the P2P system 150 that the user 101 and the merchant 130 are using for the transaction.

The card reader 136 extracts an identification number for a P2P account and initiates the transaction using the P2P system 150.

In an alternate embodiment, the merchant 130 may use a card reader 137 that is employed for traditional cards such as credit cards and debit cards. The card reader 137 or the POS terminal 134 can recognize the P2P account information associated with the account number and employ the P2P system 150 to conduct the transaction and not the traditional credit card transaction processors. If the merchant 130 uses a traditional card reader 137, the merchant 130 can select between a traditional credit card transaction and a P2P transaction. In one embodiment, wherein the user 101 associates the P2P account with a traditional credit or debit card, the merchant 130 can configure the system to attempt a P2P transaction and default to a traditional transaction if the P2P transaction is not supported or is declined. In an alternate embodiment, the merchant 130 can select the transaction type at the time of the purchase and direct the POS terminal 134 to the proper transaction account. If the merchant 130 has not configured the POS terminal 134 to accept P2P transactions, the merchant 130 can process credit or debit cards in the traditional manner. At a merchant POS terminal 134 that does not accept P2P transactions, the credit or debit card of the user 101 can default to the credit or debit account of the user that is associated with that card.

In alternate embodiments, the merchant 130 may receive the account number via any mechanism or process. For example, the user 101 may supply the number verbally, the user device 110 may communicate with the POS terminal 134 in a manner such as NFC or BLUETOOTH, the user 101 may enter a number into the user interface of the POS terminal 134, or any other mechanism or process.

In block 220, the P2P system 150 receives the transaction information and the account information of the user 101 and the merchant 130. The transaction information may contain the account or identification numbers, the purchase price of the product, location of the merchant 130, taxes, product identification, and other relevant data characterizing the transaction. The transaction information can also be transmitted from the merchant 130 to the user device 110 via any of the communication channels available to the POS terminal 134, such as NFC, BLUETOOTH, email, text, or other suitable channels.

In an exemplary embodiment, the P2P system 150 hosts accounts for both the merchant 130 and the user 101. The P2P system 150 can conduct transactions between the two accounts with lower fees than a traditional credit card charge or bank transfer. Upon completion of the transaction, the P2P system 150 can move money from the account of the user 101 to the account of the merchant 130 in an inexpensive and timely manner.

Alternatively, the merchant 130 or the user 101 may configure the P2P account to conduct a transfer with a financial account that is associated with the P2P system 150. For example, when the transaction occurs, the P2P system 150 may contact a bank or other financial institution and obtain funds to conduct the transaction from a user account located in the bank or financial institution.

The transaction information includes a request for the P2P system 150 to authorize the transaction. With confirmation from the P2P system 150 that the user account is capable of fulfilling the financial obligation the transaction imposes, the merchant 130 can continue the transaction.

In block 225, the P2P system 150 transmits a request for approval of the transaction to a user network device 110. In an exemplary embodiment, the request is transmitted to a mobile device 110 that the user 101 would expect to have at the merchant location 130. For example, the request can be sent to a P2P transaction application 115 operating on a smartphone of the user 101 via an Internet connection on the network. Other manners of transmitting the message to a user device 110 can be employed such as email, instant message, text, a message via a proximity connection with the POS terminal, or any other technology. The authorization request displays on the user device 110 to allow the user 101 to accept or reject the transaction.

In an alternate embodiment, the user 101 may configure the user account to automatically accept all authorization requests from a certain merchant 130. That is, any P2P transaction between the user 101 and the specified merchant 130 can be processed without an authorization being received from the user device 110 at the time of purchase. Alternatively, the user 101 may preauthorize a transaction before a transaction occurs. A user 101 may transmit a preauthorization for the next transaction with a specific merchant 130. For example, a user 101 may authorize a merchant 130 or a pending transaction while in line at the POS terminal 134. Additionally, the user 101 may configure limits on the preauthorization. For example, the user may limit the preauthorization to transactions that occur within a configured time from the preauthorization, that are below a configured value, or any other suitable limit.

In block 230, the method 200 determines if the user 101 authorizes the transaction. The user 101 can authorize or refuse to authorize the transaction. If the transaction information provided to the user 101 by the P2P system 150 is acceptable and the user 101 agrees to all of the terms, the user 101 can authorize the transaction. For example, if the authorization request was presented on the P2P application 115, the user 101 may click an approve button and the authorization is transmitted to the P2P system 150 via an Internet connection over the network. Alternatively, the user 101 may transmit an authorization to the P2P system 150 via a text, email, instant message, or any other suitable communication method.

The user 101 can authorize the transaction by actuating a button or other authorization module in the communication. If the user 101 does not authorize the transaction, the user 101 may actuate a button or other module that refuses the transaction.

Alternatively, if the user 101 does not authorize the transaction in a configured length of time, the P2P system 150 considers the transaction refused. For example, the P2P system 150 may allot the user 101 one minute to authorize the transaction. If the user 101 does not submit the authorization in the configured length of time, the transaction is terminated. Thus, it is necessary for the user 101 to have access to the user device 110 at the time of the purchase. The deadline may elapse without an acceptance or refusal by the user 101 because the user 101 does not have the user device 110 available for accepting the transaction, the user device 110 can not communicate with the P2P system 150, the user 101 chooses to ignore the request, or for any other reason. Alternatively, if the user 101 has preauthorized the merchant 130 or the transaction, then the transaction may proceed without an authorization from the user 101 at the time of purchase.

If the user 101 does not authorize the transaction and if the user 101 has not preauthorized the transaction or the merchant 130, the method 200 follows the “NO” branch of block 230 to block 245. If the user authorizes the transaction or if the user 101 has preauthorized the transaction or the merchant 130, the method 200 follows the “YES” branch of block 230 to block 235.

Following the “NO” branch of block 230 to block 245, the P2P system 150 cancels the transaction. In block 250, the merchant 130 is alerted that the transaction has been canceled by the P2P system 150. The merchant 130 can request an alternate form of payment from the user 101, attempt the P2P transaction again, or end the purchase transaction completely.

After block 250, the method 200 ends.

Following the “YES” branch of block 230 to block 235, the merchant 130 is notified by the P2P system 150 that the transaction has been approved. In block 240 the merchant 130 completes the transaction. The merchant 130 can deliver the product to the user 101 and issue a receipt.

After block 240, the method 200 ends.

### General

Users may, in appropriate circumstances, limit or otherwise affect the operation of the features disclosed in the specification. For example, users may be given an initial opportunity to opt-in or opt-out of the collection or use of certain data or the activation of certain features. In addition, a user may change the manner in which the features are employed, including for situations in which a user may have concerns regarding his privacy. Instructions may be provided to notify the users regarding policies about the use of information, including personally identifiable information and receipt information, and manners in which the users may affect such use of information.

One or more aspects of the invention may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing the invention in computer programming, and the invention should not be construed as limited to any one set of computer program instructions. Further, a skilled programmer would be able to write such a computer program to implement an embodiment of the disclosed invention based on the appended flow charts and associated description in the application text. Therefore, disclosure of a particular set of program code instructions is not considered necessary for an adequate understanding of how to make and use the invention. Further, those skilled in the art will appreciate that one or more aspects of the invention described herein may be performed by hardware, software, or a combination thereof, as may be embodied in one or more computing systems. Moreover, any reference to an act being performed by a computer should not be construed as being performed by a single computer as the act may be performed by more than one computer. The inventive functionality of the invention will be explained in more detail in the following description, read in conjunction with the figures illustrating the program flow.

The exemplary embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The exemplary methods and acts described in the embodiments presented previously are illustrative, and, in alternative embodiments, certain acts can be performed in a different order, in parallel with one another, omitted entirely, and/or combined between different exemplary embodiments, and/or certain additional acts can be performed, without departing from the scope and spirit of the invention. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent acts corresponding to, the disclosed aspects of the exemplary embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

1. A computer-implemented method to conduct a peer-to-peer transaction, comprising:
receiving, by a computer system from a merchant network device, a request for approval of a peer-to-peer transaction, wherein the request includes user account information captured from a magnetic strip card encoded with the user account information and transaction information for a purchase transaction;
determining, by the computer system, that the user account information is valid;
transmitting, by the computer system to a user network device associated with the user account, a request for authorization of the transaction, wherein the request comprises at least a portion of the transaction information;
receiving, by the computer system from the user network device, an authorization for the transaction that was input by a user into the user network device;
transmitting, by the computer system to the merchant network device, an approval of the transaction in response to receiving the authorization from the user network device; and
conducting, by the computer system, the transaction by debiting an account associated with the user account information and crediting an account associated with the merchant network device in an amount specified in the transaction information, wherein the computer system manages both the account associated with the user account information and the account associated with the merchant network device.

2. The method of claim 1, further comprising terminating, by the computer system, the transaction if the authorization is not received from the user network device in a predetermined length of time.

3. The method of claim 1, wherein the account information on the magnetic strip card is captured by a point of sale terminal at the merchant.

4. The method of claim 1, wherein the request for authorization is comprised of a text, instant message, or email.

5. The method of claim 1, wherein conducting the transaction comprises transferring money from the user account on the computer to an account of the merchant on the computer system.

6. A computer program product, comprising:
a non-transitory computer-readable storage device having computer-readable program instructions embodied thereon to conduct a peer-to-peer transaction, the computer-readable program instructions comprising:
computer program instructions to receive a request for approval of a peer-to-peer transaction, wherein the request includes user account information captured from a magnetic strip card encoded with the user account information and transaction information for a purchase transaction;
computer program instructions to determine that the user account information is valid;
computer program instructions to transmit to a user network device associated with the user account information a request for authorization of the transaction, wherein the request comprises at least a portion of the transaction information;
computer program instructions to receive an authorization from the user network device for the transaction;
computer program instructions to transmit an approval of the transaction in response to receiving the authorization from the user network device; and
computer program instructions to conduct the transaction by debiting an account associated with the user account information and crediting an account associated with the merchant network device in an amount specified in the transaction information, wherein the computer system manages both the account associated with the user account information and the account associated with the merchant network device.

7. The product of claim 6, further comprising computer program instructions to terminate the transaction if an authorization is not received from the user network device in a predetermined length of time.

8. The product of claim 6, wherein the user account information is entered into a user interface on a point of sale device of the merchant.

9. The product of claim 6, wherein the request for authorization is comprised of a text, instant message, or email.

10. The product of claim 6, wherein conducting the transaction comprises transferring money from the user account on the computer to an account of the merchant on the computer.

11. A system to provide an option to conduct a peer-to-peer transaction, the system comprising:
a magnetic strip card encoded with user account information;
a peer-to-peer transaction system network device;
a peer-to-peer transaction system storage resource;
a peer-to-peer processor communicatively coupled to the storage resource and the network device, wherein the processor executes application code instructions that are stored in the storage resource and that cause the system to:
receive a request for approval of a peer-to-peer transaction between a user and a merchant, wherein the request includes user account information captured from the magnetic strip card encoded with the user account information and transaction information for a purchase transaction;
determine that the user account information is valid;
transmit a request for authorization of the transaction to a user network device user network device associated with the user account information, wherein the request comprises at least a portion of the transaction information;
receive, from the user network device, an authorization for the transaction;
transmit an approval of the transaction in response to receiving the authorization from the user network device; and
conduct the transaction by debiting an account associated with the user account information and crediting an account associated with the merchant in an amount specified in the transaction information; and
an application executing on the user network device and configured to:
receive the request for authorization of the transaction from the processor, the request comprising at least a portion of the transaction information;
receive an input from the user indicating the authorization of the transaction; and
transmit the authorization of the transaction to the peer-to-peer transaction system network device.

12. The system of claim 11, wherein the peer-to-peer processor executes application code instructions that are stored in the storage resource and that cause the system to terminating the authorization of the transaction if no indication that the user authorized the transaction is received.

13. The system of claim 11, wherein the account information on the magnetic strip card is captured by a point of sale device at the merchant.

14. The system of claim 11, wherein conducting the transaction comprises transferring money from the user account on the computer to an account of the merchant on the computer.

15. The method of claim 3, wherein the point of sale terminal at the merchant only conducts transactions wherein the computer system manages both the account associated with the user account information and the account associated with the merchant network device.

16. The method of claim 1, wherein the request for authorization is transmitted to the user network device via a wireless communication between a point of sale terminal of the merchant and the user network device.

17. The method of claim 1, wherein the request for authorization is transmitted to the user network device via a network connection between the computer system and the user network device.

18. The method of claim 1, wherein the authorization received from the user network device is received via a wireless communication between a point of sale terminal of the merchant and the user network device, a network connection between the computer system and the user network device, a text, instant message, or email.

19. The method of claim 1, further comprising recognizing, by the computer system, whether the request for approval of a transaction comprises information identifying a peer-to-peer transaction, a peer-to-peer transaction being a transaction wherein the computer system manages both the account associated with the user account information and the account associated with the merchant network device.

20. The method of claim 1, further comprising receiving, by the computer system from a user network device, an authorization for all future transactions with an identified merchant, the authorization for all future transactions being input from a user to the user network device.
